(19) United States
(12) Patent Application Publication
(10) Pub. No.: US 2025/0000123 A1
(43) Pub. Date: Jan. 2, 2025

(54) Pet Food Compositions

(71) Applicant: Hill's Pet Nutrition, Inc., Overland Park, KS (US)

(72) Inventor: Matthew JACKSON, Topeka, KS (US)

(73) Assignee: Hill's Pet Nutrition, Inc., Overland Park, KS (US)

(21) Appl. No.: 18/755,193

(22) Filed: Jun. 26, 2024

Related U.S. Application Data
(60) Provisional application No. 63/510,400, filed on Jun. 27, 2023.

(51) Int. Cl. A23K 20/158; A23K 20/147; A23K 50/42

(52) U.S. Cl. CPC A23K 20/158; A23K 20/147; A23K 50/42

(57) ABSTRACT

Pet food compositions and methods for improving the wellness of a pet are disclosed herein. In one aspect, provided is a pet food composition comprising about 10 wt. % or more of fat, the fat comprising one or more short chain triglyceride; a protein; and a fiber, wherein all weight percentages are based on the total weight of the pet food composition on a dry matter basis. In another aspect, a method is provided for improving the concentration of metabolite beta-hydroxybutyrate in a pet by providing a pet food composition comprising protein, fiber, and about 7 wt. % or more of fat, the fat comprising one or more short chain triglyceride, wherein the metabolite beta-hydroxybutyrate increases by about 5% or more an hour after consumption of the pet food composition by a pet and the glucose to ketone index decreases by 10% or more.

### CROSS-REFERENCE TO RELATED APPLICATIONS

This application claims the benefit of priority from U.S. Patent Application No. 63/510,400, filed Jun. 27, 2023, titled Pet Food Compositions, the content of which are hereby incorporated herein in their entireties, for all purposes.

### BACKGROUND

Circulating energy takes many forms including glucose, fatty acids, amino acids and ketones. These energy forms are not equivalent; there is no “a calorie is a calorie” inside the body. The circulating ketone bodies in dogs comprise beta-hydroxybutyrate (BHB) and acetoacetate (AcoAc).

In periods of fasting, extreme exercise, and/or low carbohydrate consumption, glucose and glycogen stores in the body are rapidly used and can become quickly depleted. While hepatic gluconeogenesis can create new glucose from non-glucose precursors, failure to replenish glycogen stores from external sources (e.g., dietary intake of digestible carbohydrate) as they become depleted causes the body to metabolically shift to the creation of ketone bodies to maintain adequate energy. Ketone bodies can be used by almost all cells of the body as a replacement fuel to satisfy the body's energy needs, including the needs of the brain and heart.

When dietary carbohydrate is limiting, fat is predominantly burned as a primary fuel by cleaving fats into fatty acids and glycerol; fats are eventually transformed through ketogenesis into the water-soluble ketone bodies beta-hydroxybutyrate ((3-hydroxybutyrate or “BHB”), acetoacetate, and acetone. Importantly, BHB is the predominate circulating ketone body in dogs (60-90% of total ketone bodies), while acetoacetate is present at much lower levels and acetone is not able to be converted to energy by mammals.

Despite the benefits that might be achieved by reducing glucose and increase ketones, mechanisms to reduce glucose relative to ketones in canines are limited due to the resistance of this species to ketosis induced by withholding food or reducing dietary carbohydrate.

### BRIEF SUMMARY

This summary is intended merely to introduce a simplified summary of some aspects of one or more implementations of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

In accordance with an aspect of the invention, provided is a pet food composition comprising about 7 wt. % or more of fat, the fat comprising one or more short chain triglyceride; a protein; and a fiber, wherein all weight percentages are based on the total weight of the pet food composition on a dry matter basis.

In accordance with another aspect of the invention, a method is provided for improving the health of a pet, the method comprising: increasing the concentration of metabolite beta-hydroxybutyrate in a pet by providing a pet food composition comprising protein, fiber, and about 10 wt. % or more, based on the total weight of the pet food composition on a dry matter basis, of fat, the fat comprising one or more short chain triglyceride, wherein the metabolite beta-hydroxybutyrate increases by about 5% or more an hour after consumption of the pet food composition by a pet.

A list of non-limiting exemplary embodiments in accordance with certain aspects of the invention are provided below:

In accordance with embodiment 1, provided is a pet food composition comprising: about 7 wt. % or more of fat, the fat comprising one or more short chain triglyceride; a protein; and a fiber, wherein all weight percentages are based on the total weight of the pet food composition on a dry matter basis.

In accordance with embodiment 2, provided is the pet food composition according to embodiment 1, wherein the short chain triglyceride has one or more fatty acid components comprising 1 to 6 carbons.

In accordance with embodiment 3, provided is the pet food composition according to embodiment 1 or embodiment 2, wherein the short chain triglyceride has one or more fatty acid components comprising 1 to 4 carbons.

In accordance with embodiment 4, provided is the pet food composition according to any foregoing embodiment, wherein the short chain triglyceride has two or more fatty acid components comprising 1 to 4 carbons.

In accordance with embodiment 5, provided is the pet food composition according to any foregoing embodiment, wherein the short chain triglyceride has three fatty acid components comprising 1 to 4 carbons.

In accordance with embodiment 6, provided is the pet food composition according to any foregoing embodiment, wherein composition comprising tributyrin, triacetin, tripropionin, or a combination thereof.

In accordance with embodiment 7, provided is the pet food composition according to any foregoing embodiment, wherein the short chain triglyceride comprises about 10 wt. % or more of the total amount of fat.

In accordance with embodiment 8, provided is the pet food composition according to any foregoing embodiment, wherein the protein is present in an amount from about 15 to 55 wt. %.

In accordance with embodiment 9, provided is the pet food composition according to any foregoing embodiment, wherein the fiber is present in an amount from about 1 to about 15 wt. %.

In accordance with embodiment 10, provided is the pet food composition according to any foregoing embodiment further comprising carbohydrate, optionally in an amount of up to about 65 wt. %.

In accordance with embodiment 11, provided is the pet food composition according to any foregoing embodiment, wherein the pet food composition is formulated to increase in the concentration of metabolite beta-hydroxybutyrate by about 5% or more, as assessed about one hour after consumption of the pet food composition by a pet consuming a recommended daily nutritional intake of the pet food composition for a single meal.

In accordance with embodiment 12, provided is the pet food composition according to any foregoing embodiment, wherein the pet food composition is formulated to decrease the glucose to ketone index of a pet by about 12% or more, as assessed about one hour after consumption of the pet food composition by a pet consuming a recommended daily nutritional intake of the pet food composition for a single meal.

In accordance with embodiment 13, provided is the pet food composition according to any foregoing embodiment, wherein the pet food composition is formulated such that a pet has a glucose to ketone index from about 35 to about 59, as assessed about one hour after consumption of the pet food composition by a pet consuming a recommended daily nutritional intake of the pet food composition for a single meal.

In accordance with an embodiment 14, a method is provided for improving the health of a pet, the method comprising: increasing the concentration of metabolite beta-hydroxybutyrate in a pet by providing a pet food composition comprising protein, fiber, and about 8 wt. % or more of fat, based on the total weight of the pet food composition on a dry matter basis, the fat comprising one or more short chain triglyceride, wherein the amount of metabolite beta-hydroxybutyrate increases by about 5% or more an hour after consumption of the pet food composition by a pet.

In accordance with embodiment 15, provided is the method according to 14, wherein the method decreases the glucose to ketone index of a pet by about 12% or more, as assessed about one hour after consumption of the pet food composition by the pet.

In accordance with embodiment 16, provided is the method according to embodiment 14 or embodiment 15, wherein the pet has a glucose to ketone index from about 35 to about 59, as assessed about one hour after consumption of the pet food composition by the pet in the form of a single meal provided once a day for at least one day.

In accordance with embodiment 17, provided is the method according to any one of embodiment 14 to embodiment 16, wherein the pet is Canis familiaris.

In accordance with embodiment 18, provided is the method according to any one of embodiment 14 to embodiment 17, wherein the pet is Felis domesticus.

In accordance with embodiment 19, provided is a pet supplement composition comprising: about 7 wt. % or more of fat, the fat comprising one or more short chain triglyceride; a protein; and a fiber, wherein all weight percentages are based on the total weight of the pet food composition on a dry matter basis.

In accordance with embodiment 20, provided is a pet supplement composition according to embodiment 19, wherein the short chain triglyceride has two or more fatty acid components comprising 1 to 4 carbons.

In accordance with embodiment 21, provided is a pet supplement composition according to embodiment 19 or embodiment 20, wherein the short chain triglyceride has two or more fatty acid components comprising 1 to 4 carbons.

In accordance with embodiment 22, provided is a pet supplement composition according to any one of embodiments 19 to 21, wherein the short chain triglyceride has two or more fatty acid components comprising 1 to 4 carbons.

In accordance with embodiment 23, provided is a pet supplement composition according to any one of embodiments 19 to 22, wherein the short chain triglyceride has three fatty acid components comprising 1 to 4 carbons.

In accordance with embodiment 24, provided is a pet supplement composition according to any one of embodiments 19 to 23, wherein the short chain triglyceride has three fatty acid components comprising 1 to 4 carbons.

In accordance with embodiment 25, provided is a pet supplement composition according to any one of embodiments 19 to 24, wherein composition comprising tributyrin, triacetin, tripropionin, or a combination thereof.

In accordance with embodiment 26, provided is a pet supplement composition according to any one of embodiments 19 to 25, wherein the short chain triglyceride comprises about 10 wt. % or more of the total amount of fat.

### DETAILED DESCRIPTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other compositions and methods. Before explaining the disclosed embodiments of the present invention in detail, it is to be understood that the invention is not necessarily limited in its application to the details of any particular embodiment disclosed. The terminology used herein is for the purpose of description and not of limitation.

As used herein and in the appended claims, the singular forms “a”, “an”, and “the” include plural references unless the context dictates otherwise. The singular form of any class of the ingredients refers not only to one ingredient within that class, but also to a mixture of those ingredients. The terms “a” (or “an”), “one or more” and “at least one” may be used interchangeably herein. The terms “comprising”, “including”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range. Thus, a range from 1-5, includes specifically 1, 2, 3, 4 and 5, as well as subranges such as 2-5, 3-5, 2-3, 2-4, 1-4, etc. The term “about” when referring to a number means any number within a range of 10% of the number. For example, the phrase “about 2.0 wt. %” refers to a number between and including 1.8 wt. % and 2.2 wt. %.

All references cited herein are hereby incorporated by reference in their entireties. In the event of a conflict in a definition in the present disclosure and that of a cited reference, the present disclosure controls.

The abbreviations and symbols as used herein, unless indicated otherwise, take their ordinary meaning. The abbreviation “wt. %” means percent by weight with respect to the pet food composition. The symbol “°” refers to a degree, such as a temperature degree or a degree of an angle. The symbols “h”, “min”, “mL”, “nm”, “μm” means hour, minute, milliliter, nanometer, and micrometer, respectively. The abbreviation “UV-VIS” referring to a spectrometer or spectroscopy, means Ultraviolet-Visible. The abbreviation “rpm” means revolutions per minute.

Any member in a list of species that are used to exemplify or define a genus, may be mutually different from, or overlapping with, or a subset of, or equivalent to, or nearly the same as, or identical to, any other member of the list of species. Further, unless explicitly stated, such as when reciting a Markush group, the list of species that define or exemplify the genus is open, and it is given that other species may exist that define or exemplify the genus just as well as, or better than, any other species listed.

All components and elements positively set forth in this disclosure can be negatively excluded from the claims. In other words, the pet food compositions of the instant disclosure can be free or essentially free of all components and elements positively recited throughout the instant disclosure. In some instances, the pet food compositions of the present disclosure may be substantially free of non-incidental amounts of the ingredient(s) or compound(s) described herein. A non-incidental amount of an ingredient or compound is the amount of that ingredient or compound that is added into the pet food composition by itself. For example, a pet food composition may be substantially free of a non-incidental amount of an ingredient or compound, although such ingredient(s) or compound(s) may be present as part of a raw material that is included as a blend of two or more compounds. Substantially free, unless other defined or described herein, typically refers to an ingredient or compound in an amount of about 2 wt. % or less, about 1.5 wt. % or less, about 1 wt. % or less, about 0.5 wt. % or less, about 0.1 wt. % or less, or about 0.05 wt. % or less, or about 0.01 wt. % or less, based on the total weight of the pet food composition on a dry matter basis.

Some of the various categories of components identified may overlap. In such cases where overlap may exist and the pet food composition includes both components (or the composition includes more than two components that overlap), an overlapping compound does not represent more than one component. For example, certain components or ingredients may be characterized as both an ancient grain and an amaranth. If a particular pet food care composition recites both an ancient grain and an amaranth, a compound that may be characterized as both an ancient and an amaranth will serve only as either an ancient or an amaranth—not both.

As used herein, the term “pet” could be used interchangeably with “companion animal” and refers to an animal of any species kept by a caregiver as a pet or any animal of a variety of species that have been widely domesticated as pets, including canines (Canis familiaris) and felines (Felis domesticus). Thus, a pet may include but is not limited to, working dogs, pet dogs, cats kept for rodent control (e.g., farm cats), pet cats, ferrets, birds, reptiles, rabbits, and fish.

To the extent that food and food ingredient contain water/moisture, the dry matter represents everything in the sample other than water including, for example, protein, fiber, fat, carbohydrates, minerals, etc. Dry matter weight is the total weight minus the weight of any water. The skilled artisan would readily recognize and understand nutritional amounts and percentages expressed as dry matter amounts, dry matter weights and dry matter percentages.

Dry matter intake per day is calculated as the total nutritional intake per day excluding all water. For example, an amount of an ingredient equal to a specific percent of daily nutritional intake refers to the amount of that ingredient in dry matter form (i.e., excluding all water) relative to the total amount of dry matter consumed (also excluding all water) in a day.

“Daily nutritional intake” and “total nutritional intake per day” refer to dry matter intake per day. That is, water weight is not included in calculating the amount of nutrition consumed per day. To calculate percent of an ingredient of total daily intake on a dry matter basis, water is removed from the total intake to give total daily dry matter intake and the percentage of the ingredient is based on amount of ingredient present as dry matter.

As used herein, an “ingredient” refers to any component of a pet food composition. The term “nutrient” refers to a substance that provides nourishment and thus has a nutrient value. In some cases, an ingredient may comprise more than one “nutrient,” for example, a composition may comprise corn comprising important nutrients including both protein and carbohydrate.

Aspects of the invention are directed to pet food compositions and methods of use thereof for improving the health and/or wellness of a pet. The inventors recognized that during a prolonged fast in dogs, for example, blood ketone levels will increase to approximately 1 mmol/L. When fed food restricted in carbohydrate and high in fat is fed to dogs for extended periods of time (>4 weeks) the dogs will manifest a more moderate level of circulating BHB (˜0.15 mM, measured after an overnight fast). In contrast, levels of BHB in overnight fasted dogs that have been chronically been consuming foods replete with carbohydrates are approximately 0.9 mM. It is believed that the heart, brain and peripheral tissues use BHB in the proportion that they are available in blood relative to glucose. The balance between glucose and ketones in circulation is quantified in a metric referred to herein as the Glucose to Ketone Index (Glucose: Ketone Index) that incorporates the relative levels of these two metabolic fuel. Proportionate decreases in glucose utilization and increases in ketone utilization by organs occur when the GKI decreases.

Without being limited to any theories, it is believed that the canine brain uses BHB as a fuel concomitant with circulating levels such that the brain increasingly utilizes BHB for fuel at the expense of glucose utilization as the Glucose to Ketone Index decreases and BHB can replace glucose as fuel in the hypoglycemic dog. Further, kidneys both produce and consume ketones as fuel which is an unusual status; the only other organ to make sizable amounts of BHB is the liver and the liver does not consume BHB as fuel. For instance, it is believed that ketones can serve as up to 50% of the kidney's energy needs. Similarly, the heart is believed to have a proclivity to utilize BHB as a fuel source, and provision of ketogenic fats, such as medium chain triglycerides (MCT; having 6, 8, or 10 carbon saturated acyl chains), can be converted to BHB for fuel by the heart.

Without being limited to any particular theory, medium chain triglycerides are believed to be less than optimal substrates for pancreatic lipase, and other triglycerides may more readily be hydrolyzed by pancreatic lipase and thus more readily generate substrates for hepatic BHB production. Further, triglycerides containing additional fatty acids (or fatty acid components/residues) aside from the C6, C8, C10 constituents of medium chain triglycerides may more readily generate BHB than typical medium chain triglycerides. But if a shorter chain fat improves BHB production from a given triglyceride, then inclusion of C6, C8, and C10 medium chain fatty acids (MCFA) detracts from that production by filling formulation space that could have otherwise been devoted to shorter chain fats (e.g., C2, C3, C4; SCFA). Although they may be more efficient at producing BHB, the triglycerides composed of purely short chain fatty acid (SCFA) were traditionally believed to pose challenges in feeding to companion animals as they are perceived to be of poor palatability and thus food rejection may limit their consumption.

In accordance with an aspect of the invention, provided is a pet food composition comprising about 7 wt. % or more of fat, the fat comprising one or more short chain triglyceride; a protein; and a fiber, wherein all weight percentages are based on the total weight of the pet food composition on a dry matter basis.

Preferably, the pet food compositions are formulated to increase in the concentration of metabolite beta-hydroxybutyrate by about 5% or more, as assessed about one hour after consumption of the pet food composition by a pet consuming a recommended daily nutritional intake of the pet food composition for about a month, and in some embodiments after a single meal. For instance, the pet food composition may increase the concentration of circulating metabolite beta-hydroxybutyrate by about 10% or more, by about 12% or more, about 14% or more, about 16% or more, about 18% or more, about 20% or more, about 22% or more, about 24% or more, about 26% or more, about 28% or more, or about 30% or more, as assessed about one hour after consumption of the pet food composition by a pet consuming a recommended daily nutritional intake of the pet food composition for about a month (about 30 days) prior to the assessment, and in some embodiments after a single meal. In accordance with some embodied methods, the increase in the concentration of circulating metabolite beta-hydroxybutyrate of about 10% or more, by about 12% or more, about 14% or more, about 16% or more, about 18% or more, about 20% or more, about 22% or more, about 24% or more, about 26% or more, about 28% or more, or about 30% or more is achieved about one hour after the pet consumes a recommended daily nutritional intake of the pet food composition in a single meal. In accordance with further embodied methods, the increase in the concentration of circulating metabolite beta-hydroxybutyrate of about 12% or more, about 14% or more, about 16% or more, about 18% or more, about 20% or more, about 22% or more, about 24% or more, about 26% or more, about 28% or more, or about 30% or more is achieved about one hour after the pet consumes a recommended daily nutritional intake of the pet food composition in a single meal, where the pet has consumed the recommended daily nutritional intake of the pet food composition in a single meal for the prior 30 days or about a month.

Additionally or alternatively, the pet food composition may be formulated to decrease the glucose to ketone index of a pet by about 12% or more, as assessed about one hour after consumption of the pet food composition by a pet consuming a recommended daily nutritional intake of the pet food composition for about a month (e.g., about 30 days) prior to the assessment, and in some embodiments after a single meal. In certain embodiments, pet food composition is adapted to decrease the glucose to ketone index of a pet by about 14% or more, about 16% or more, about 18% or more, about 20% or more, about 22% or more, about 24% or more, about 26% or more, about 28% or more, or about 30% or more, as assessed about one hour after consumption of the pet food composition by a pet consuming a recommended daily nutritional intake of the pet food composition for about a month (about 30 days) prior to the assessment, and in some embodiments after a single meal. For instance, in accordance with some embodied methods, the decrease in the decrease of the glucose to ketone index of about 14% or more, about 16% or more, about 18% or more, about 20% or more, about 22% or more, about 24% or more, about 26% or more, about 28% or more, or about 30% or more is achieved about one hour after the pet consumes a recommended daily nutritional intake of the pet food composition in a single meal. In accordance with additional embodiment methods, the decrease in the decrease of the glucose to ketone index of about 14% or more, about 16% or more, about 18% or more, about 20% or more, about 22% or more, about 24% or more, about 26% or more, about 28% or more, or about 30% or more is achieved about one hour after the pet consumes a recommended daily nutritional intake of the pet food composition in a single meal, where the pet has consumed the recommended daily nutritional intake of the pet food composition in a single meal for the prior 30 days or about a month.

The inventors discovered that the pet food compositions may be adapted to achieve a glucose to ketone index ratio from about 35 to about 59, as assessed about one hour after consumption of the pet food composition by a pet consuming a recommended daily nutritional intake of the pet food composition for about a month (e.g., about 30 days) prior to the assessment, and in some embodiments after a single meal. For example, the pet food compositions may be formulated to provide a glucose to ketone index ratio of about 35 to about 57, about 35 to about 55, about 35 to about 53, about 35 to about 51, about 35 to about 49, about 35 to about 47, about 35 to about 45; from about 38 to about 59, about 38 to about 57, about 38 to about 55, about 38 to about 53, about 38 to about 51, about 38 to about 49, about 38 to about 47, about 38 to about 45; from about 41 to about 59, about 41 to about 57, about 41 to about 55, about 41 to about 53, about 41 to about 51, about 41 to about 49, about 41 to about 47, about 41 to about 45; from about 43 to about 59, about 43 to about 57, about 43 to about 55, about 43 to about 53, about 43 to about 51, about 43 to about 49, about 43 to about 47; from about 45 to about 59, about 45 to about 57, about 45 to about 55, about 45 to about 53, about 45 to about 51, about 45 to about 49; or any range or subrange thereof, as assessed about one hour after consumption of the pet food composition by a pet consuming a recommended daily nutritional intake of the pet food composition for about a month (e.g., about 30 days) prior to the assessment, and in some embodiments after a single meal.

In accordance with some embodied methods, the glucose to ketone index ratio from about 35 to about 59, about 35 to about 57, about 35 to about 55, about 35 to about 53, about 35 to about 51, about 35 to about 49, about 35 to about 47, about 35 to about 45; from about 38 to about 59, about 38 to about 57, about 38 to about 55, about 38 to about 53, about 38 to about 51, about 38 to about 49, about 38 to about 47, about 38 to about 45; from about 41 to about 59, about 41 to about 57, about 41 to about 55, about 41 to about 53, about 41 to about 51, about 41 to about 49, about 41 to about 47, about 41 to about 45; from about 43 to about 59, about 43 to about 57, about 43 to about 55, about 43 to about 53, about 43 to about 51, about 43 to about 49, about 43 to about 47; from about 45 to about 59, about 45 to about 57, about 45 to about 55, about 45 to about 53, about 45 to about 51, or about 45 to about 49 is obtained about one hour after the pet consumes a recommended daily nutritional intake of the pet food composition in a single meal. In accordance with additional embodied methods, the glucose to ketone index ratio from about 35 to about 59, about 35 to about 57, about 35 to about 55, about 35 to about 53, about 35 to about 51, about 35 to about 49, about 35 to about 47, about 35 to about 45; from about 38 to about 59, about 38 to about 57, about 38 to about 55, about 38 to about 53, about 38 to about 51, about 38 to about 49, about 38 to about 47, about 38 to about 45; from about 41 to about 59, about 41 to about 57, about 41 to about 55, about 41 to about 53, about 41 to about 51, about 41 to about 49, about 41 to about 47, about 41 to about 45; from about 43 to about 59, about 43 to about 57, about 43 to about 55, about 43 to about 53, about 43 to about 51, about 43 to about 49, about 43 to about 47; from about 45 to about 59, about 45 to about 57, about 45 to about 55, about 45 to about 53, about 45 to about 51, or about 45 to about 49 is obtained about one hour after the pet consumes a recommended daily nutritional intake of the pet food composition in a single meal, where the pet has consumed the recommended daily nutritional intake of the pet food composition in a single meal for the prior 30 days or about a month.

The glucose to ketone index ratio is the molar concentration of glucose to the molar concentration of ketone (e.g., BHB). A description of the procedures for determining the glucose to ketone index ratio can found in Nutr. Metab. (Lond). 2015 Mar. 11; 12:12. doi: 10.1186/s12986-015-0009-2. PMID: 25798181; PMCID: PMC4367849, which is incorporated herein by reference in its entirety for all purposes.

The recommended daily nutritional intake may be based on AAFCO and NRC nutrition recommendations, which are based on based on 1) a dry matter inclusion level when diets are 4000 kcal/kg or less and 2) per 1000 kcal when diets are higher than 4000 kcal/kg in energy.

Suitable components, such as those listed below, may be included or excluded from the formulations for the pet food compositions depending on the specific combination of other ingredients and the form of the pet food compositions. In some embodiments, the pet food compositions disclosed herein may be in the form of a stand-alone pet food, as a supplement to pet food, as a pet food treat, or the like. For instance, the pet food composition may be in the form of a supplement and have certain components and/or ingredients in amounts disclosed herein.

The pet food compositions are formulated to include fat in an amount typically ranging from about 7 wt. % or more, based on the total weight of the pet food composition on a dry matter basis. For example, the amount of fat present in the pet food composition may be in a range from about 7 to about 60 wt. %, about 7 to about 55 wt. %, about 7 to about 50 wt. %, about 7 to about 45 wt. %, about 7 to about 40 wt. %, about 7 to about 35 wt. %, about 7 to about 30 wt. %, about 7 to about 25 wt. %, about 7 to about 20 wt. %; from about 8.5 to about 60 wt. %, about 8.5 to about 55 wt. %, about 8.5 to about 50 wt. %, about 8.5 to about 45 wt. %, about 8.5 to about 40 wt. %, about 8.5 to about 35 wt. %, about 8.5 to about 30 wt. %, about 8.5 to about 25 wt. %, about 8.5 to about 20 wt. %; from about 10 to about 60 wt. %, about 10 to about 55 wt. %, about 10 to about 50 wt. %, about 10 to about 45 wt. %, about 10 to about 40 wt. %, about 10 to about 35 wt. %, about 10 to about 30 wt. %, about 10 to about 25 wt. %, about 10 to about 20 wt. %; from about 20 to about 60 wt. %, about 20 to about 55 wt. %, about 20 to about 50 wt. %, about 20 to about 45 wt. %, about 20 to about 40 wt. %, about 20 to about 35 wt. %, about 20 to about 30 wt. %; from about 23 to about 60 wt. %, about 23 to about 55 wt. %, about 23 to about 50 wt. %, about 23 to about 45 wt. %, about 23 to about 40 wt. %, about 23 to about 35 wt. %; from about 26 to about 60 wt. %, about 26 to about 55 wt. %, about 26 to about 50 wt. %, about 26 to about 45 wt. %, about 26 to about 40 wt. %, about 26 to about 35 wt. %; from about 29 to about 60 wt. %, about 29 to about 55 wt. %, about 29 to about 50 wt. %, about 29 to about 45 wt. %, about 29 to about 40 wt. %, about 29 to about 35 wt. %; from about 32 to about 60 wt. %, about 32 to about 55 wt. %, about 32 to about 50 wt. %, about 32 to about 45 wt. %, about 32 to about 40 wt. %, based on the total weight of the pet food composition on a dry matter basis.

The term “fat” generally refers to a lipid or mixture of lipids suitable for dietary consumption. The fat in the pet food composition typically comprises one or more short chain triglyceride(s). As used herein, “short chain triglycerides” refers to a triglyceride having at least one aliphatic carbon chain comprised of 1 to 5 carbons. For example, a medium chain triglyceride may have one, two, or three aliphatic carbons chains of 1 to 5 carbons. For example, the pet food composition may comprise two, three, four, five, six, seven or more triglycerides, all of which may be selected from short chain triglycerides. In some embodiments, one or more of the aliphatic carbon chains of the short chain triglyceride comprises 1, 2, 3, 4, or 5 carbons. For example, one or more of the aliphatic carbon chains of the short chain triglyceride may comprise from 1 to 5 carbons, 1 to 4 carbons, 1 to 3 carbons; from 2 to 5 carbons, 2 to 4 carbons, or 3 to 5 carbons. Although in some embodiments, each of the three aliphatic chains of the short chain triglyceride is comprised of the same number of carbons, in other embodiments the short chain triglyceride has aliphatic chains having any of the foregoing ranges or numbers of carbons. One or more of the aliphatic chains of the short chain triglycerides may comprise a fatty acid residue or fatty acid component, e.g., where the fatty acid residue or component is comprised of any of the foregoing ranges or numbers of carbons. In at least one embodiment, the short chain triglyceride is tributyrin (also referred to as butyryl triglyceride or glyceryl tributyrate), triacetin, tripropionin, or a combination thereof.

In at least one preferred embodiment, the short chain triglyceride has an aliphatic carbon chain having 2 to 4 carbons. For example, the short chain triglyceride may have one, two, or three aliphatic carbon chains having 2 to 4 carbons. In certain preferred embodiments, the short chain triglyceride has all three aliphatic carbon chains with 2 to 4 carbons.

The short chain triglyceride(s) may comprise about 1 wt. % or more of the fat in the pet food composition, based on the total amount of the fat in the pet food composition on a dry matter basis. For example, the fat of the pet food composition may be comprised of about 1 up to 100 wt. % of short chain triglyceride(s), based on the total amount of the fat in the pet food composition on a dry matter basis. In some embodiments, the short chain triglyceride(s) may comprise from about 1 to about 60 wt. %, about 1 to about 45 wt. %, about 1 to about 40 wt. %, about 1 to about 34 wt. %, about 1 to about 28 wt. %, about 1 to about 22 wt. %, about 1 to about 17 wt. %, about 1 to about 12 wt. %, about 1 to about 7 wt. %, about 1 to about 5 wt. %, about 1 to about 3 wt. %; from about 3 to about 60 wt. %, about 3 to about 45 wt. %, about 3 to about 40 wt. %, about 3 to about 34 wt. %, about 3 to about 28 wt. %, about 3 to about 22 wt. %, about 3 to about 17 wt. %, about 3 to about 12 wt. %, about 3 to about 7 wt. %, about 3 to about 5 wt. %; from about 5 to about 60 wt. %, about 5 to about 45 wt. %, about 5 to about 40 wt. %, about 5 to about 34 wt. %, about 5 to about 28 wt. %, about 5 to about 22 wt. %, about 5 to about 17 wt. %, about 5 to about 12 wt. %, about 5 to about 8 wt. %; from about 7 to about 60 wt. %, about 7 to about 50 wt. %, about 7 to about 45 wt. %, about 7 to about 40 wt. %, about 7 to about 37 wt. %, about 7 to about 34 wt. %, about 7 to about 31 wt. %, about 7 to about 28 wt. %, about 7 to about 25 wt. %, about 7 to about 22 wt. %, about 7 to about 17 wt. %, about 7 to about 12 wt. %; from about 12 to about 60 wt. %, about 12 to about 50 wt. %, about 12 to about 45 wt. %, about 12 to about 40 wt. %, about 12 to about 37 wt. %, about 12 to about 34 wt. %, about 12 to about 31 wt. %, about 12 to about 28 wt. %, about 12 to about 25 wt. %, about 12 to about 22 wt. %, about 12 to about 17 wt. %; from about 17 to about 60 wt. %, about 17 to about 50 wt. %, about 17 to about 45 wt. %, about 17 to about 40 wt. %, about 17 to about 37 wt. %, about 17 to about 34 wt. %, about 17 to about 31 wt. %, about 17 to about 28 wt. %, about 17 to about 25 wt. %; from about 23 to about 60 wt. %, about 23 to about 50 wt. %, about 23 to about 45 wt. %, about 23 to about 40 wt. %, about 23 to about 37 wt. %, about 23 to about 34 wt. %, about 23 to about 31 wt. %; from about 27 to about 60 wt. %, about 27 to about 50 wt. %, about 27 to about 45 wt. %, about 27 to about 40 wt. %, about 27 to about 37 wt. %, about 27 to about 34 wt. %, about 27 to about 31 wt. %; from about 31 to about 60 wt. %, about 31 to about 50 wt. %, about 31 to about 45 wt. %, about 31 to about 40 wt. %, about 31 to about 37 wt. %; from about 35 to about 60 wt. %, about 35 to about 50 wt. %, about 35 to about 45 wt. %, about 35 to about 40 wt. %; from about 39 to about 60 wt. %, about 39 to about 50 wt. %, about 39 to about 45 wt. %; from about 43 to about 60 wt. %, about 43 to about 50 wt. %, about 47 to about 60 wt. %, or any range or subrange thereof, of the fat of the pet food composition, based on the total weight of the fat in the pet food composition on a dry matter basis.

In some instances, the short chain triglyceride(s) comprise from about 50 up to 100 wt. %, of the total amount of fat, based on the total amount of the fat in the pet food composition on a dry matter basis. For instance, the pet food composition may be in the form of a supplement have short chain triglyceride(s) comprising about 55 up to 100 wt. %, about 60 up to 100 wt. %, about 65 up to 100 wt. %, about 70 up to 100 wt. %, about 75 up to 100 wt. %, about 80 up to 100 wt. %, about 85 up to 100 wt. %, about 90 up to 100 wt. %, about 95 up to 100 wt. %; from about 50 to about 95 wt. %, about 55 to about 95 wt. %, about 60 to about 95 wt. %, about 65 to about 95 wt. %, about 70 to about 95 wt. %, about 75 to about 95 wt. %, about 80 to about 95 wt. %, about 85 to about 95 wt. %, about 90 to about 95 wt. %; from about 50 to about 90 wt. %, about 55 to about 90 wt. %, about 60 to about 90 wt. %, about 65 to about 90 wt. %, about 70 to about 90 wt. %, about 75 to about 90 wt. %, about 80 to about 90 wt. %, about 85 to about 90 wt. %; from about 50 to about 85 wt. %, about 55 to about 85 wt. %, about 60 to about 85 wt. %, about 65 to about 85 wt. %, about 70 to about 85 wt. %, about 75 to about 85 wt. %, about 80 to about 85 wt. %; from about 50 to about 80 wt. %, about 55 to about 80 wt. %, about 60 to about 80 wt. %, about 65 to about 80 wt. %, about 70 to about 80 wt. %, about 75 to about 80 wt. %; from about 50 to about 75 wt. %, about 55 to about 75 wt. %, about 60 to about 75 wt. %, about 65 to about 75 wt. %, about 70 to about 75 wt. %; from about 50 to about 70 wt. %, about 55 to about 70 wt. %, about 60 to about 70 wt. %, about 65 to about 70 wt. %; from about 50 to about 65 wt. %, about 55 to about 65 wt. %, about 60 to about 65 wt. %; from about 50 to about 60 wt. %, about 55 to about 60 wt. %, or any range or subrange thereof, of the total amount of fat, based on the total amount of the fat in the pet food composition on a dry matter basis. In at least one embodiment, the fat consists essentially of or consists of short chain triglyceride(s).

Additionally or alternatively, the pet food composition may have the short chain triglyceride(s) in an amount from about 0.1 to about 6 wt. %, based on the total weight of the pet food composition on a dry matter basis. In some cases, the pet food composition may have the short chain triglyceride(s) in an amount from about 0.1 to about 6 wt. %, about 0.1 to about 5 wt. %, about 0.1 to about 4 wt. %, about 0.1 to about 3 wt. %, about 0.1 to about 2 wt. %, about 0.1 to about 1 wt. %; from about 0.5 to about 6 wt. %, about 0.5 to about 5 wt. %, about 0.5 to about 4 wt. %, about 0.5 to about 3 wt. %, about 0.5 to about 2 wt. %, about 0.5 to about 1 wt. %; from about 1 to about 6 wt. %, about 1 to about 5 wt. %, about 1 to about 4 wt. %, about 1 to about 3 wt. %, about 1 to about 2 wt. %, about 1 to about 1.5 wt. %; from about 1.5 to about 6 wt. %, about 1.5 to about 5 wt. %, about 1.5 to about 4 wt. %, about 1.5 to about 3 wt. %, about 1.5 to about 2 wt. %; from about 2 to about 6 wt. %, about 2 to about 5 wt. %, about 2 to about 4 wt. %, about 2 to about 3 wt. %; from about 2.5 to about 6 wt. %, about 2.5 to about 5 wt. %, about 2.5 to about 4 wt. %, about 2.5 to about 3 wt. %; from about 3.5 to about 6 wt. %, about 3.5 to about 5 wt. %, about 3.5 to about 4.5 wt. %, about 4.5 to about 6 wt. %, or any range or subrange thereof, based on the total weight of the pet food composition on a dry matter basis.

The pet food compositions may be formulated to have about 10 wt. % or less of medium triglycerides, based on the total amount of the fat in the pet food composition on a dry matter basis. As used herein, “medium chain triglycerides” refers to a triglyceride having at least one aliphatic carbon chain comprised of 6 to 12 carbons. In some embodiments, the pet food composition may have medium triglycerides in an amount of about 10 wt. % or less, about 8 wt. % or less, about 7 wt. % or less, about 6 wt. % or less, about 5 wt. % or less, about 4 wt. % or less, about 3 wt. % or less, about 2 wt. % or less, about 1 wt. % or less, or about 0.5 wt. % or less, based on the total amount of the fat in the pet food composition on a dry matter basis. In some embodiments, the pet food composition may include an amount of medium chain triglycerides, such as from about 1 to 10 wt. %, about 1 to 7 wt. %, about 1 to 5 wt. %, about 1 to 3 wt. %; from about 3 to 10 wt. %, about 3 to 7 wt. %, about 3 to 5 wt. %; about 5 to 10 wt. %, about 5 to 7 wt. %, or about 7 to 10 wt. %, based on the total amount of the fat in the pet food composition on a dry matter basis.

The pet food composition may include one or more triglyceride comprising a fatty acid residue or component. The fatty acid residue or component, in some embodiments, may be selected from omega-3 fatty acids, omega-6 fatty acids, or a combination of two or more thereof. Examples of omega-3 fatty acid components that may comprise the aliphatic chain of the additional triglyceride include those selected from linolenic acid, stearidonic acid, eicosatetraenoic acid, eicosapentaenoic acid, docosapentaenoic acid, and/or docosahexaenoic acid. Examples of omega-6 fatty acid components that may comprise the aliphatic chain of an additional triglyceride include linolenic acid, calendic acid, eicosadienoic acid, arachidonic acid, docosadienoic acid, adrenic acid, osbond acid, tetracosatetraenoic acid, and/or tetracosapentaenoic acid. In some embodiments, the polyunsaturated fatty acid component of the additional triglyceride is selected from linolenic acid, and/or arachidonic acid.

The pet food compositions may, optionally, include one or more fatty acid(s). The fatty acid(s) when present in the pet food composition is typically in an amount from about 0.1 to about 5 wt. %, based on the total weight of the pet food composition on a dry matter basis. For example, the fatty acid may present in an amount from about 0.1 to about 4 wt. %, about 0.1 to about 3 wt. %, about 0.1 to about 2 wt. %, about 0.1 to about 1 wt. %; from about 0.5 to about 5 wt. %, about 0.5 to about 4 wt. %, about 0.5 to about 3 wt. %, about 0.5 to about 2 wt. %; from about 1 to about 5 wt. %, about 1 to about 4 wt. %, about 1 to about 3 wt. %, about 1 to about 2 wt. %; from about 2 to about 5 wt. %, about 2 to about 4 wt. %, about 2 to about 3 wt. %; from about 3 to about 5 wt. %, about 3 to about 4 wt. %, or any range or subrange thereof, based on the total weight of the pet food composition.

The one or more fatty acid(s) may be selected from omega-3 fatty acids, omega-6 fatty acids, lauric acid, myristic acid, palmitic acid, palmitoleic acid, margaric acid, margaroleic acid, stearic acid, oleic acid, stearidonic acid, gadoleic acid, behenic acid, erucic acid, docosatetra acid, and a combination of two or more thereof. In at least one preferred embodiment, the one or more fatty acid comprises an omega-3 fatty acid, an omega-6 fatty acid, or a combination of two or more thereof. Examples of omega-3 fatty acids include linolenic acid, stearidonic acid, eicosatetraenoic acid, eicosapentaenoic acid, docosapentaenoic acid, and docosahexaenoic acid. Examples of omega-6 fatty acids include linoleic acid, calendic acid, eicosadienoic acid, arachidonic acid, docosadienoic acid, adrenic acid, osbond acid, tetracosatetraenoic acid, and tetracosapentaenoic acid.

The pet food composition, in some embodiments, comprises one or more omega-3 fatty acid and one or more omega-6 fatty acid. In some instance, the pet food composition is formulated to have a weight ratio of omega-3 fatty acid(s) to omega-6 fatty acid(s) of from about 0.5:1 to about 7:1, about 0.5:1 to about 3:1, about 0.5:1 to about 2.5:1, about 0.5:1 to about 2:1, about 0.5:1 to about 1.5:1, about 0.5:1 to about 1:1, about 0.6:1 to about 7:1, about 0.6:1 to about 3:1, about 0.6:1 to about 2.5:1, about 0.6:1 to about 2:1, about 0.6:1 to about 1.5:1, or about 0.6:1 to about 1:1.

The fat may be incorporated completely within the food composition, deposited on the outside of the pet food composition, or a mixture of the two methods. In some embodiments, the pet food compositions further include an effective amount of one or more substances selected from the group consisting of glucosamine, chondroitin, chondroitin sulfate, methylsulfonylmethane (“MSM”), creatine, antioxidants, Perna canaliculata, and mixtures thereof.

Fat can be supplied by any of a variety of sources known by those skilled in the art, including meat, meat by-products, canola oil, fish oil such as anchovy oil and menhaden oil, and plants. Meat fat sources include poultry fat, turkey fat, pork fat, lard, tallow, and beef fat. Plant fat sources include wheat, flaxseed, rye, barley, rice, sorghum, corn, oats, millet, wheat germ, corn germ, soybeans, peanuts, and cottonseed, as well as oils derived from these and other plant fat sources such as corn oil, soybean oil, cottonseed oil, palm oil, palm kernel oil, linseed oil, canola oil, rapeseed oil, and/or olestra.

In some cases, the fat in the pet food composition is a crude fat. Crude fat may be included into the compositions in the amounts disclosed above with respect of the total fat, such as from about 8 to about 50 wt. %, based on the total weight of the pet food composition on a dry matter basis. In some embodiments, the pet food composition comprises crude fat in an amount of about 8 to about 40 wt. %, about 12 to about 35 wt. %, about 14 to about 30 wt. %, about 16 to about 24 wt. %, based on the total weight of the pet food composition on a dry matter basis. In some cases, it may be preferable that about 50 wt. % or more, about 60 wt. % or more, about 70 wt. % or more, about 80 wt. % or more, or about 90 wt. % or more of the total fat is obtained from an animal source. Alternatively, about 50 wt. % or more, about 60 wt. % or more, about 70 wt. % or more, about 80 wt. % or more, or about 90 wt. % or more of the total fat may be obtained from a plant source.

The pet food composition includes protein in an amount that may vary. For instance, the pet food composition may include protein in an amount from about 15 to about 55 wt. %, based on the total weight of the pet food composition on a dry matter basis. In some embodiments, the amount of protein present in the pet food composition is from about 15 to about 50 wt. %, about 15 to about 45 wt. %, about 15 to about 40 wt. %, about 15 to about 35 wt. %, about 15 to about 30 wt. %; about 20 to about 55 wt. %, about 20 to about 50 wt. %, about 20 to about 45 wt. %, about 20 to about 40 wt. %, about 20 to about 35 wt. %, about 20 to about 30 wt. %; from about 23 to about 55 wt. %, about 23 to about 50 wt. %, about 23 to about 45 wt. %, about 23 to about 40 wt. %, about 23 to about 35 wt. %; from about 26 to about 55 wt. %, about 26 to about 50 wt. %, about 26 to about 45 wt. %, about 26 to about 40 wt. %, about 26 to about 35 wt. %; from about 29 to about 55 wt. %, about 29 to about 50 wt. %, about 29 to about 45 wt. %, about 29 to about 40 wt. %, about 29 to about 35 wt. %; from about 32 to about 55 wt. %, about 32 to about 50 wt. %, about 32 to about 45 wt. %, about 32 to about 40 wt. %; from about 35 to about 55 wt. %, about 35 to about 50 wt. %, about 35 to about 45 wt. %, about 35 to about 40 wt. %; from about 38 to about 55 wt. %, about 38 to about 50 wt. %, about 38 to about 45 wt. %; from about 41 to about 55 wt. %, about 41 to about 50 wt. %; or from about 43 to about 55 wt. %, including ranges or subranges thereof, based on the total weight of the pet food composition on a dry matter basis.

The protein of the pet food composition may comprises one or more amino acids selected from Tryptophan, Taurine, Histidine, Carnitine, Carnosine, Alanine, Cysteine, Arginine, Methionine (including DL-methionine, and L-methionine), Tryptophan, Lysine, Asparagine, Aspartate (Aspartic acid), Phenylalanine, Valine, Threonine, Isoleucine, Histidine, Leucine, Glycine, Glutamine, Taurine, Tyrosine, Homocysteine, Ornithine, Citruline, Glutamate (Glutamic acid), Proline, and/or Serine, and a combination of two or more thereof. In some cases, the one or more amino acid(s) may comprise essential amino acids. Essential amino acids are amino acids that cannot be synthesized de novo, or in sufficient quantities by an organism and thus must be supplied in the diet. Essential amino acids vary from species to species, depending upon the organism's metabolism. For example, it is generally understood that the essential amino acids for dogs and cats (and humans) are phenylalanine, leucine, methionine, lysine, isoleucine, valine, threonine, tryptophan, histidine and arginine. In addition, taurine, while technically not an amino acid but a derivative of cysteine, is an essential nutrient for cats.

A portion of the protein in the composition may be predigested (pre-hydrolyzed) protein. For example, the composition may include an amount of protein, where about 40 wt. % or more, about 50 wt. % or more, about 60 wt. % or more, about 70 wt. % or more, about 80 wt. % or more, about 90 wt. % or more, about 95 wt. % or more, about 98 wt. % or more, or about 99 wt. % or more of the protein is predigested (pre-hydrolyzed) protein. In some embodiments, e.g., when the composition desirable promotes weight loss, the portion of protein that is predigested (pre-hydrolyzed) protein is about 60 wt. % or less, about 50 wt. % or less, about 40 wt. % or less, about 30 wt. % or less, about 20 wt. % or less, or about 10 wt. % or less, based on the total amount of protein in the pet food composition on a dry matter basis. In further embodiment, the amount of protein that is predigested (pre-hydrolyzed) protein is about 10 to about 99 wt. %, about 10 to about 95 wt. %, about 10 to about 90 wt. %, about 10 to about 70 wt. %, about 10 to about 50 wt. %, about 10 to about 30 wt. %; about 30 to about 99 wt. %, about 30 to about 95 wt. %, about 30 to about 90 wt. %, about 30 to about 70 wt. %, about 30 to about 50 wt. %; about 50 to about 99 wt. %, about 50 to about 95 wt. %, about 50 to about 90 wt. %, about 50 to about 70 wt. %; or about 70 to about 99 wt. %, about 70 to about 95 wt. %, about 70 to about 90 wt. %, including ranges and subranges therein, based on the total amount of protein in the pet food composition on a dry matter basis.

Protein may be supplied by any of a variety of sources known by those of ordinary skill in the art including plant sources, animal sources, microbial sources or a combination of these. For example, animal sources may include meat, meat-by products, seafood, dairy, eggs, etc. Meats, for example, may include animal flesh such as poultry, fish, and mammals including cattle, pigs, sheep, goats, and the like. Meat by-products may include, for example, lungs, kidneys, brain, livers, stomachs and intestines. Plant protein includes, for example, soybean, cottonseed, and peanuts. Microbial sources may be used to synthesize amino acids (e.g., lysine, threonine, tryptophan, methionine) or intact protein such as protein from sources listed below.

Examples of protein or protein ingredients may comprise chicken meals, chicken, chicken by-product meals, lamb, lamb meals, turkey, turkey meals, beef, beef by-products, viscera, fish meal, enterals, kangaroo, white fish, venison, soybean meal, soy protein isolate, soy protein concentrate, corn gluten meal, corn protein concentrate, distillers dried grains, and/or distillers dried grain solubles and single-cell proteins, for example yeast, algae, and/or bacteria cultures.

The protein can be intact, completely hydrolyzed, or partially hydrolyzed. The protein content of foods may be determined by any number of methods known by those of skill in the art, for example, as published by the Association of Official Analytical Chemists in Official Methods of Analysis (“OMA”), method 988.05. The amount of protein in a composition disclosed herein may be determined based on the amount of nitrogen in the composition according to methods familiar to one of skill in the art.

The pet food composition may be formulated to have a total amount of fiber. In some embodiments, the pet food composition includes from about 1 to about 15 wt. % of fiber, based on the total weight of the pet food composition on a dry matter basis. For example, the total amount of fiber in the pet food composition may be from about 1 to about 12 wt. %, about 1 to about 9 wt. %, about 1 to about 7 wt. %, about 1 to about 5 wt. %, about 1 to about 4 wt. %, about 1 to about 3 wt. %, about 1 to about 2 wt. %; from about 2 to about 15 wt. %, about 2 to about 12 wt. %, about 2 to about 9 wt. %, about 2 to about 7 wt. %, about 2 to about 5 wt. %, about 2 to about 4 wt. %, about 2 to about 3 wt. %; from about 4 to about 15 wt. %, about 4 to about 12 wt. %, about 4 to about 9 wt. %, about 4 to about 7 wt. %, about 4 to about 5 wt. %; from about 6 to about 15 wt. %, about 6 to about 12 wt. %, about 6 to about 9 wt. %, about 6 to about 7 wt. %; from about 8 to about 15 wt. %, about 8 to about 12 wt. %, about 8 to about 9 wt. %; from about 10 to about 15 wt. %, about 10 to about 12 wt. %, about 12 to about 15 wt. %, or any ranges or subranges thereof, based on the total weight of the pet food composition on a dry matter basis.

In alternative embodiments, the amount of fiber present in the pet food composition may be from about 10 to about 55 wt. %, about 10 to about 50 wt. %, about 10 to about 45 wt. %, about 10 to about 40 wt. %, about 10 to about 35 wt. %, about 10 to about 30 wt. %; from about 15 to about 60 wt. %, about 15 to about 55 wt. %, about 15 to about 50 wt. %, about 15 to about 45 wt. %, about 15 to about 40 wt. %, about 15 to about 35 wt. %, about 15 to about 30 wt. %; from about 20 to about 60 wt. %, about 20 to about 55 wt. %, about 20 to about 50 wt. %, about 20 to about 45 wt. %, about 20 to about 40 wt. %, about 20 to about 35 wt. %, about 20 to about 30 wt. %; from about 25 to about 60 wt. %, about 25 to about 55 wt. %, about 25 to about 50 wt. %, about 25 to about 45 wt. %, about 25 to about 40 wt. %, about 25 to about 35 wt. %; from about 30 to about 60 wt. %, about 30 to about 55 wt. %, about 30 to about 50 wt. %, about 30 to about 45 wt. %, about 30 to about 40 wt. %; from about 35 to about 60 wt. %, about 35 to about 55 wt. %, about 35 to about 50 wt. %, about 35 to about 45 wt. %; from about 40 to about 60 wt. %, about 40 to about 55 wt. %, about 40 to about 50 wt. %; from about 45 to about 60 wt. %, about 45 to about 55 wt. %, about 50 to about 60 wt. %, or ranges and subranges thereof, based on the total weight of the pet food composition on a dry matter basis.

The total amount of fiber present in the pet food composition generally comprises an amount of crude fiber and dietary fiber. The amount of crude fiber and/or dietary fiber may be present in the pet food compositions in any of the above amounts disclosed for the total amount of fiber. Crude fiber includes indigestible components contained in cell walls and cell contents of plants such as grains, e.g., hulls of grains such as rice, corn, and beans.

In some embodiments, crude fiber comprises the majority of the total amount of fiber. In at least one embodiment, the crude fiber comprises about 55 wt. % or more, about 65 wt. % or more, about 75 wt. % or more, about 80 wt. % or more, about 85 wt. % or more, about 90 wt. % or more, about 95 wt. % or more, or about 98 wt. % or more of the total amount of fiber in the pet food composition, based on the total weight of the pet food composition on a dry matter basis. In a further embodiment, the total amount of fiber consists essentially of or consists of crude fiber.

Dietary fiber refers to components of a plant that are resistant to digestion by an animal's digestive enzymes. Dietary fiber includes soluble fiber and insoluble fiber. Soluble fibers are resistant to digestion and absorption in the small intestine and undergo complete or partial fermentation in the large intestine, e.g., beet pulp, guar gum, chicory root, psyllium, pectin, blueberry, cranberry, squash, apples, oats, beans, citrus, barley, or peas. Insoluble fibers can be supplied by any of a variety of sources, including, for example, cellulose, whole-wheat products, wheat oat, corn bran, flax seed, grapes, celery, green beans, cauliflower, potato skins, fruit skins (e.g., pear skin), vegetable skins, peanut hulls, almond shell, walnut shell, pecan shell, citrus pulp, beet pulp, and soy fiber. In some embodiments, the dietary fiber may be chosen from pecan shell, citrus pulp, beet pulp, and a combination of two or more thereof. Crude fiber includes indigestible components contained in cell walls and cell contents of plants such as grains, for example, hulls of grains such as rice, corn, and beans.

In some embodiments, the pet food compositions may include one or more sclereid. The one or more sclereids may be obtained from nut shells, such as pecan shells, almonds shells, walnut shells, etc.; from seeds, such as pea, bean, soybean seeds, etc.; and/or from fruit skins, such as pear skin, etc. In one embodiment, the pet food composition includes pecan shell particles comprising one or more sclereids. The sclereid(s) may have a microscopic structure and, preferably, serve as an abrasive. For instance, the sclereid(s) may be selected to provide mechanical disruption of debris, food, and/or bacteria on the teeth of a pet consuming a pet food composition disclosed herein, which contains such sclereid(s). In at least one embodiment, the sclereid(s) may be selected to include one or more polyphenols.

In some embodiments, the pet food composition has a weight ratio of insoluble fiber to soluble fiber from about 20:1 to about 8:1. For example, the pet food composition may have a weight ratio of insoluble fiber to soluble fiber from about 18:1 to about 8:1, about 16:1 to about 8:1, about 14:1 to about 8:1, about 12:1 to about 8:1, about 10:1 to about 8:1. The pet food composition may have a weight ratio of insoluble fiber to soluble fiber of about 11:1.

The pet food composition may further comprise ash. As described herein, ash consists of compounds that are not organic or water, generally produced by combustion of biological materials. The ash may be present in the pet food composition in an amount ranging from about 1 to about 10 wt. %, based on the total weight of the food composition on a dry weight basis, including all amounts and sub-ranges there-between. In some embodiment, the ash may be present in the food composition in an amount ranging from about 1 to about 8 wt. %, about 1 to about 6 wt. %, about 1 to about 5 wt. %, about 1 to about 4 wt. %, about 1 to about 3 wt. %, about 1 to about 2 wt. %; from about 2 to about 10 wt. %, about 2 to about 8 wt. %, about 2 to about 6 wt. %, about 2 to about 5 wt. %, about 2 to about 4 wt. %; from about 3 to about 10 wt. %, about 3 to about 8 wt. %, about 3 to about 6 wt. %, about 3 to about 5 wt. %; from about 4 to about 10 wt. %, about 4 to about 8 wt. %, about 4 to about 6 wt. %; from about 5 to about 10 wt. %, about 5 to about 8 wt. %, or any range or subrange thereof, based on the total weight of the food composition on a dry weight basis.

The amount of carbohydrate, e.g., calculated as NFE, present in the composition may be from an amount up to about 65 wt. %, an amount up to about 60 wt. %, an amount up to about 55 wt. %, an amount up to about 50 wt. %, an amount up to about 45 wt. %, an amount up to about 40 wt. %, an amount up to about 35 wt. %, an amount up to about 30 wt. %, an amount up to about 25 wt. %, an amount up to about 20 wt. %, an amount up to about 15 wt. %, an amount up to about 10 wt. %, an amount up to about 5 wt. %; about 1 to about 65 wt. %, about 1 to about 55 wt. %, about 1 to about 50 wt. %, about 1 to about 45 wt. %, about 1 to about 40 wt. %, about 1 to about 35 wt. %; about 1 to about 30 wt. %, about 1 to about 25 wt. %, about 1 to about 20 wt. %, about 1 to about 15 wt. %, about 1 to about 10 wt. %, about 1 to about 5 wt. %; about 5 to about 65 wt. %, about 5 to about 55 wt. %, about 5 to about 50 wt. %, about 5 to about 45 wt. %, about 5 to about 40 wt. %, about 5 to about 35 wt. %; about 5 to about 30 wt. %, about 5 to about 25 wt. %, about 5 to about 20 wt. %, about 5 to about 15 wt. %; about 10 to about 65 wt. %, about 10 to about 55 wt. %, about 10 to about 50 wt. %, about 10 to about 45 wt. %, about 10 to about 40 wt. %, about 10 to about 35 wt. %; about 10 to about 30 wt. %, about 10 to about 25 wt. %; about 15 to about 65 wt. %, about 15 to about 55 wt. %, about 15 to about 50 wt. %, about 15 to about 45 wt. %, about 15 to about 40 wt. %, about 15 to about 35 wt. %; about 15 to about 30 wt. %; about 20 to about 65 wt. %, about 20 to about 55 wt. %, about 20 to about 50 wt. %, about 20 to about 45 wt. %, about 20 to about 40 wt. %, about 20 to about 35 wt. %; about 25 to about 65 wt. %, about 25 to about 55 wt. %, about 25 to about 50 wt. %, about 25 to about 45 wt. %, about 25 to about 40 wt. %, about 25 to about 35 wt. %; about 30 to about 65 wt. %, about 30 to about 55 wt. %, about 30 to about 50 wt. %, about 30 to about 45 wt. %; about 35 to about 65 wt. %, about 35 to about 55 wt. %, about 35 to about 50 wt. %; about 40 to about 65 wt. %, about 40 to about 55 wt. %, about 45 to about 65 wt. %, about 45 to about 55 wt. %; or about 50 to about 65 wt. %, including ranges and subranges thereof, based on the total weight of the pet composition on a dry matter basis.

The term “carbohydrate” as used herein includes polysaccharides (e.g., starches and dextrins) and sugars (e.g., sucrose, lactose, maltose, glucose, and fructose) that are metabolized for energy when hydrolyzed. Generally, carbohydrate percentage can be calculated as nitrogen free extract (“NFE”), which can be calculated as follows: NFE %=100%−(moisture %)−(protein %)−(fat %)−(ash %)−(crude fiber %). One skilled in the art could manipulate the texture of the final product by properly balancing carbohydrate sources. For example, short chain polysaccharides lend to be sticky and gluey, and longer chain polysaccharides are less sticky and gluey than the shorter chain; the desired texture of this hybrid food is achieved by longer chain polysaccharide and modified starches such as native or modified starches, cellulose and the like. The carbohydrate mixture may additionally comprise optional components such as added salt, spices, seasonings, vitamins, minerals, flavorants, colorants, and the like. The amount of the optional components is at least partially dependent on the nutritional requirements for different life stages of animals.

Carbohydrates can be supplied by any of a variety of sources known by those skilled in the art, including, but not limited to, oat fiber, cellulose, peanut hulls, beet pulp, parboiled rice, cornstarch, corn gluten meal, cereal, and sorghum. Grains supplying carbohydrates can include, but are not limited to, wheat, durum, semolina, corn, barley, and rice. In certain embodiments, the carbohydrate component comprises a mixture of one or more carbohydrate sources. Carbohydrates content of foods can be determined by any number of methods known by those of skill in the art.

In certain embodiments, the pet food composition comprises moisture. The moisture may be present at various amounts or concentrations. In one embodiment, moisture may be present in an amount of from about 3 to about 20 wt. %, based on the total weight of the pet food composition. For example, moisture may be present in an amount of about 3 wt. %, about 5 wt. %, about 5.5 wt. %, about 6 wt. %, about 6.5 wt. %, about 7 wt. %, about 7.5 wt. %, about 8 wt. %, about 8.5 wt. %, about 9 wt. %, about 9.5 wt. %, about 10 wt. %, about 10.5 wt. %, about 11 wt. %, about 11.5 wt. %, about 12 wt. %, about 12.5 wt. %, about 13 wt. %, about 13.5 wt. %, about 14 wt. %, about 14.5 wt. %, or about 15 wt. %, based on the total weight of the pet food composition. In another example, moisture may be present in an amount of from about 6% to about 12%, about 9% to about 13%, about 9% to about 11%, or about 9% to about 13%, based on the total weight of the pet food composition. In certain embodiments, moisture is present in an amount of about 5% to about 12%, about 6% to about 11%, or about 7% to about 10.0%, based on the total weight of the pet food composition. In further embodiments, moisture is present in an amount of about 65% to about 85%, about 60% to about 80%, or about 60% to about 75%, based on the total weight of the pet food composition.

The pet food compositions disclosed herein may be wet or dry compositions, and the ingredients can be either incorporated into the food composition and/or on the surface of any composition component, such as, for example, by spraying, agglomerating, dusting, or precipitating on the surface. Additionally, the pet food compositions may be formulated and produced to be in various forms and/or consistencies. For instance, the pet food compositions may, for example, be a dry, moist or semi-moist animal food composition. “Semi-moist” refers to a food composition containing from about 25 to about 35% moisture. “Moist” food refers to a food composition that has a moisture content of about 60 to 90% or greater. “Dry” food refers to a food composition with about 3 to about 12% moisture content and is often manufactured in the form of small bits or kibbles.

The food products may also include components of more than one consistency, for example, soft, chewy meat-like particles or pieces as well as kibble having an outer coating and an inner “core” component. In some embodiments, the pet food compositions may be in the form of a kibble or food kibble. As used herein, the term “kibble” or “food kibble” refers to a particulate pellet, e.g., like a component of feline or canine feeds. In some embodiments, a food kibble has a moisture, or water, content of less than 15% by weight. Food kibbles may range in texture from hard to soft. Food kibbles may range in internal structure from expanded to dense. Food kibbles may be formed by an extrusion process or a baking process. In non-limiting examples, a food kibble may have a uniform internal structure or a varied internal structure. For example, a food kibble may include a core and a coating to form a coated kibble. It should be understood that when the term “kibble” or “food kibble” is used, it can refer to an uncoated kibble or a coated kibble.

The pet food composition of the present disclosure can additionally comprise other additives in amounts and combinations familiar to one of skill in the art. Such additives should be present in amounts that do not impair the purpose and effect provided by the invention. Examples of additives include substances with a stabilizing effect, organoleptic substances, processing aids, and substances that provide nutritional benefits.

Stabilizing substances may include, by way of example, substances that tend to increase the shelf life of the pet food composition. Other examples of other such additives potentially suitable for inclusion in the compositions of the invention include, for example, preservatives, antioxidants, synergists and sequestrants, packaging gases, stabilizers, emulsifiers, thickeners, gelling agents, and humectants. Examples of emulsifiers and/or thickening agents include gelatin, cellulose ethers, starch, starch esters, starch ethers, and modified starches. Additives for coloring, palatability, and nutritional purposes can include colorants, salts (including, but not limited to, sodium chloride, potassium citrate, potassium chloride, and other edible salts), vitamins, minerals, and flavoring. Other additives can include glucosamine, chondroitin sulfate, vegetable extracts, herbal extracts, etc.

The concentration of such additives in the pet food composition typically can be up to about 5 wt. %, based on the total weight of the pet food composition on a dry matter basis. For example, the additives may be present in an amount from about 0.01 to about 5 wt. %, about 0.01 to about 4 wt. %, about 0.01 to about 4 wt. %, about 0.01 to about 3 wt. %, about 0.01 to about 2 wt. %, about 0.01 to about 1 wt. %; about 0.1 to about 5 wt. %, about 0.1 to about 4 wt. %, about 0.1 to about 4 wt. %, about 0.1 to about 3 wt. %, about 0.1 to about 2 wt. %, about 0.1 to about 1 wt. %; about 1 to about 5 wt. %, about 1 to about 4 wt. %, about 1 to about 4 wt. %, about 1 to about 3 wt. %, about 1 to about 2 wt. %; about 2 to about 5 wt. %, about 2 to about 4 wt. %, about 2 to about 4 wt. %, about 2 to about 3 wt. %; about 3 to about 5 wt. %, about 3 to about 4 wt. %; about 4 to about 5 wt. %, or any range or subrange thereof, based on the total weight of the pet food composition on a dry matter basis. In some embodiments, the concentration of such additives (particularly where such additives are primarily nutritional balancing agents, such as vitamins and minerals) is from about 0 to about 2 wt. %, based on the total weight of the pet food composition on a dry matter basis. The amount of additives comprising vitamins may be in addition to the amount of vitamin B discussed above. In some embodiments, the concentration of such additives (again, particularly where such additives are primarily nutritional balancing agents) is from about 0 to about 1 wt. %, based on the total weight of the pet food composition on a dry matter basis. Although the list of foregoing additives may be potentially suitable in some embodiments, one or more of the foregoing additives may be excluded from other embodiments of the pet food composition.

In specific embodiments, the pet food compositions and food products are formulated to address specific nutritional differences between species and breeds of animals, as well as one of more of the attributes of the animal. For example, cat and dog foods, for example, are typically formulated based upon the life stage, age, size, weight, body composition, and breed.

Sources of proteins, carbohydrates, fats, vitamins, minerals, balancing agents, and the like, suitable for inclusion in the pet food compositions, and particularly in the food products to be administered in methods provided herein, may be selected from among those conventional materials known to those of ordinary skill in the art.

The pet food compositions may include, or in some instance exclude, one or more ingredients selected from beef broth, brewers dried yeast, egg, egg product, flax meal, DL methionine, amino acids, leucine, lysine, arginine, cysteine, cystine, aspartic acid, polyphosphates, sodium pyrophosphate, sodium tripolyphosphate; zinc chloride, copper gluconate, stannous chloride, stannous fluoride, sodium fluoride, triclosan, glucosamine hydrochloride, chondroitin sulfate, green lipped mussel, blue lipped mussel, methyl sulfonyl methane (MSM), boron, boric acid, phytoestrogens, phytoandrogens, genistein, diadzein, Lcarnitine, chromium picolinate, chromium tripicolinate, chromium nicotinate, acid/base modifiers, potassium citrate, potassium chloride, calcium carbonate, calcium chloride, sodium bisulfate; eucalyptus, lavender, peppermint, plasticizers, colorants, flavorants, sweeteners, buffering agents, slip aids, carriers, pH adjusting agents, natural ingredients, stabilizers, biological additives such as enzymes (including proteases and lipases), chemical additives, coolants, chelants, denaturants, drug astringents, emulsifiers, external analgesics, fragrance compounds, humectants, opacifying agents (such as zinc oxide and titanium dioxide), antifoaming agents (such as silicone), preservatives (such as butylated hydroxytoluene (BHT) and butylated hydroxyanisole (BHA), propyl gallate, benzalkonium chloride, EDTA, benzyl alcohol, potassium sorbate, parabens and mixtures thereof), reducing agents, solvents, hydrotropes, solubilizing agents, suspending agents (non-surfactant), solvents, viscosity increasing agents (aqueous and non-aqueous), sequestrants, keratolytics, egg shell membrane, ancient grain, and a combination of two or more thereof.

The pet food composition may be produced by various methods to achieve the desired pet food composition or desired form for the pet food composition. For example, dry food may be baked or extruded, then cut into individual shaped portions, such as kibbles. In some embodiments, the pet food composition may be prepared in a canned or wet form using conventional food preparation processes known to those of ordinary skill in the art. Typically, ground animal proteinaceous tissues are mixed with the other ingredients, such as cereal grains, suitable carbohydrate sources, fats, oils, and balancing ingredients, including special purpose additives such as vitamin and mineral mixtures, inorganic salts, cellulose, beet pulp and the like, and water in an amount sufficient for processing. The ingredients are mixed in a vessel suitable for heating while blending the components. Heating the mixture is carried out using any suitable manner, for example, direct steam injection or using a vessel fitted with a heat exchanger. Following addition of all of the ingredients of the formulation, the mixture may be heated to a temperature of from 50° F. to 212° F. Although temperatures outside this range can be used, they may be commercially-impractical without the use of other processing aids. When heated to the appropriate temperature, the material will typically be in the form of thick liquid, which is dispensed into cans. A lid is applied and the container is hermetically sealed. The sealed can is then placed in convention equipment designed for sterilization of the contents. Sterilization is usually accomplished by heating to temperatures of greater than 230° C. for an appropriate time depending on the temperature used, the nature of the composition, and related factors. The pet food compositions and food products of the present disclosure can also be added to or combined with food compositions before, during, or after their preparation.

In some embodiments, the food products (e.g., pet food composition, pet food supplement, or the like) may be prepared in a dry form using convention processes known to those of ordinary skill in the art. Typically, dry ingredients, including dried animal protein, plant protein, grains and the like are ground and mixed together. Liquid or moist ingredients, including fats, oils water, animal protein, water, and the like are added combined with the dry materials. The specific formulation, order of addition, combination, and methods and equipment used to combine the various ingredients can be selected from those known in the art. For example, in certain embodiments, the resulting mixture is process into kibbles or similar dry pieces, which are formed using an extrusion process in which the mixture of dry and wet ingredients is subjected to mechanical work at high pressure and temperature, forced through small openings or apertures, and cut off into the kibbles, e.g., with a rotating knife. Kibbles may also be prepared from dough by baking, rather than extrusion, in which the dough is placed into a mold before dry-heat processing.

In preparing a composition, any ingredient generally may be incorporated into the composition during the processing of the formulation, e.g., during and/or after mixing of the other components of the composition. Distribution of these components into the pet food composition can be accomplished by conventional means. In certain embodiments, ground animal and/or poultry proteinaceous tissues are mixed with other ingredients, including nutritional balancing agents, inorganic salts, and may further include cellulose, beet pulp, bulking agents and the like, along with sufficient water for processing.

In accordance with another aspect of the invention, a method is provided for improving the health of a pet, the method comprising: increasing the concentration of metabolite beta-hydroxybutyrate (BHB) in a pet by providing a pet food composition comprising protein, fiber, and about 10 wt. % or more, based on the total weight of the pet food composition on a dry matter basis, of fat, the fat comprising one or more short chain triglyceride, wherein the metabolite beta-hydroxybutyrate increases by about 5% or more an hour after consumption of the pet food composition by a pet.

In some instances, the method may include providing and/or feeding the canine the pet food compositions for 1 or more days, preferably 5 or more days, preferably 7 or more days, preferably 10 or more days, preferably 14 or more days, preferably 30 or more days, or preferably 42 or more days. The method may include feeding the pet one time a day, two times a day, three times a day, or in some embodiments four or more times a day.

Preferably, the methods employing certain pet food compositions disclosed herein increase the concentration of circulating metabolite beta-hydroxybutyrate by about 10% or more, as assessed about one hour after consumption of the pet food composition by a pet consuming a recommended daily nutritional intake of the pet food composition for about a month prior to the assessment, and for some embodiments after a single meal. The method may preferably increase the concentration of circulating metabolite beta-hydroxybutyrate by about 12% or more, about 14% or more, about 16% or more, about 18% or more, about 20% or more, about 22% or more, about 24% or more, about 26% or more, about 28% or more, or about 30% or more, about one hour after consumption of the pet food composition by a pet consuming a recommended daily nutritional intake of the pet food composition for about a month prior to the assessment, and for some embodiments after a single meal.

Additionally or alternatively, the methods employing certain pet food compositions disclosed herein may decrease the glucose to ketone index of the pet. In certain embodiments, the method decreases the glucose to ketone index of a pet by about 12% or more, as assessed about one hour after consumption of the pet food composition by a pet consuming a recommended daily nutritional intake of the pet food composition for about a month prior to the assessment, and for some embodiments after a single meal. For instance, method may decrease the glucose to ketone index of a pet by about 14% or more, about 16% or more, about 18% or more, about 20% or more, about 22% or more, about 24% or more, about 26% or more, about 28% or more, or about 30% or more, as assessed about one hour after consumption of the pet food composition by a pet consuming a recommended daily nutritional intake of the pet food composition for about a month prior to the assessment, and for some embodiments after a single meal.

The methods employing certain pet food compositions disclosed herein may achieve the foregoing increases the concentration of circulating metabolite beta-hydroxybutyrate and/or decrease the glucose to ketone index, as measured about one hour after consumption of the pet food composition by a pet consuming a recommended daily nutritional intake of the pet food composition as the sole pet food source for about a month prior to the assessment, and for some embodiments after just one single meal.

In some embodiments, the method employs a pet food composition that achieves a glucose to ketone index of from about 35 to about 59, as assessed about one hour after consumption of the pet food composition by a pet consuming a recommended daily nutritional intake of the pet food composition for about a month prior to the assessment, and for some embodiments after just one single meal. The method mays provide a glucose to ketone index, in some cases, of about 35 to about 57, about 35 to about 55, about 35 to about 53, about 35 to about 51, about 35 to about 49, about 35 to about 47, about 35 to about 45; from about 38 to about 59, about 38 to about 57, about 38 to about 55, about 38 to about 53, about 38 to about 51, about 38 to about 49, about 38 to about 47, about 38 to about 45; from about 41 to about 59, about 41 to about 57, about 41 to about 55, about 41 to about 53, about 41 to about 51, about 41 to about 49, about 41 to about 47, about 41 to about 45; from about 43 to about 59, about 43 to about 57, about 43 to about 55, about 43 to about 53, about 43 to about 51, about 43 to about 49, about 43 to about 47; from about 45 to about 59, about 45 to about 57, about 45 to about 55, about 45 to about 53, about 45 to about 51, about 45 to about 49; or any range or subrange thereof, as assessed about one hour after consumption of the pet food composition by a pet consuming a recommended daily nutritional intake of the pet food composition for about a month prior to the assessment, and for some embodiments after just one single meal.

### EXAMPLES

### Example 1

A non-limiting example of a pet food composition (Example Composition) was prepared in accordance with aspects of the present invention. Example Composition was prepared according to the formulation show in Table 1 (below). A comparative pet food composition (Comparative Composition) was prepared having the same formulation as the Example Composition, except that Comparative Composition had 2 wt. % of chicken fat instead of 2 wt. % of tributyrin, based on the total weight of the pet food composition on a dry matter basis.

TABLE 1

| | Comparative | Ex. Comp. |
|---|---|---|
| Description | Comp. (wt. %) | (wt. %) |
| Hulled Rice | 30-40 | 30-40 |
| Chicken Fat | 10-15 | 5-15 |
| Brown Rice | 5-15 | 5-15 |
| Sorghum | 5-15 | 5-15 |
| Beet Pulp | 1-10 | 1-10 |
| Dried Egg | 1-10 | 1-10 |
| Palatants | 1-7 | 1-7 |
| Dried Chicken | 1-5 | 1-5 |
| Corn gluten meal | 1-5 | 1-5 |
| Fish Oil | 1-5 | 1-5 |
| Calcium carbonate | 1-5 | 1-5 |
| Lactic acid (84%) | 1-5 | 1-5 |
| Soybean Oil | 0.1-3 | 0.1-3 |
| Lysine, 1, hydrochloride | 0.1-1 | 0.1-1 |
| Potassium chloride | 0.1-1 | 0.1-1 |
| Trimethylglycine | 0.1-1 | 0.1-1 |
| Carnitine, 1 (10%) | 0.1-1 | 0.1-1 |
| Oat bran | 0.1-1 | 0.1-1 |
| Methionine, dl | 0.1-1 | 0.1-1 |
| Vitamin Premixes | 0.1-1 | 0.1-1 |
| Fructooligosaccharides | 0.1-1 | 0.1-1 |
| Potassium citrate | 0.1-1 | 0.1-1 |
| Choline chloride (70%) | 0.1-1 | 0.1-1 |
| Threonine, 1 | 0.1-1 | 0.1-1 |
| Sodium chloride, iodized | 0.05-0.5 | 0.05-0.5 |
| Taurine | 0.05-0.5 | 0.05-0.5 |
| Vitamin E (50%) | 0.05-0.25 | 0.05-0.25 |
| Mineral Premix | 0.01-0.1 | 0.01-0.1 |
| Tryptophan, 1 | 0.01-0.1 | 0.01-0.1 |
| Magnesium oxide | 0.01-0.1 | 0.01-0.1 |
| Tributyrin | 0 | 0.1-5 |

### Example 2

Twelve dogs were fed Example Composition or Comparative Composition and evaluated to assess the effect of the Example Composition. All of the dogs were adult (>1 years old) neutered males and spayed females of small and medium size. The dogs were considered healthy when there was no evidence of chronic systemic disease from physical examination, complete blood count, serum biochemical analyses, urinalysis, or fecal examination for parasites; exclusion criteria were recorded instances of gastrointestinal upset (vomiting, diarrhea) or abnormally low appetite.

All dogs were pair-housed in indoor rooms with natural light. Dogs received behavioral enrichment by interacting with each other, as well as through play time with caretakers, daily opportunities to run outside in groups on feature-rich grassy areas (play parks), and access to toys. The dogs were fed once daily and had ad libitum access to water. All dogs were immunized against canine distemper, adenovirus, parvovirus, Bordetella, and rabies, were monitored for parasites, and received routine heartworm preventative.

Each of the canines was fed a standard canine adult maintenance formula for 30 days, as part of a pre-feed regimen. After the 30 day pre-feed regimen, the dogs were split into two groups in a randomized manner, with one group receiving a single meal of Comparative Composition 1 or Example Composition A. Blood was drawn from each of the dogs for clinical biochemistry one hour after the dogs were fed their respective meals. The blood was then analyzed for select metabolic and clinical markers as well as for BHB and glucose (from which the GKI can be calculated). A summary of the blood assessment is provided below in Table 2.

TABLE 2

| | Comparative | | | | |
|---|---|---|---|---|---|
| | Comp. | | Ex. Comp. | | t-Test |
| Analyte | Mean | Std Err | Mean | Std Err | Prob > \|t\| |
| Glucose mM | 4.64 | 0.15 | 4.39 | 0.12 | 0.1925 |
| BHB mM | 0.077 | 0.002 | 0.095 | 0.005 | 0.0040 |
| Glucose:Ketone Index | 61.16 | 2.88 | 47.65 | 3.02 | 0.0038 |
| (GKI) mM:mM | | | | | |
| AST (U/L) | 34.58 | 4.44 | 33.25 | 2.49 | 0.7956 |
| ALT (U/L) | 29.75 | 2.47 | 32.00 | 2.50 | 0.5281 |
| GGT (U/L) | 3.17 | 0.21 | 3.25 | 0.39 | 0.8525 |
| Albumin (g/dL) | 2.93 | 0.08 | 2.90 | 0.06 | 0.7427 |
| Bicarbonate TCO2 | 25.75 | 0.72 | 25.42 | 0.81 | 0.7614 |
| (mmol/L) | | | | | |
| Chloride (mmol/L) | 112.08 | 0.71 | 111.50 | 0.65 | 0.5501 |
| Potassium (mmol/L) | 4.59 | 0.08 | 4.60 | 0.11 | 0.9492 |
| Sodium (mmol/L) | 147.83 | 0.44 | 146.92 | 0.53 | 0.1967 |
| LDH (U/L) | 115.67 | 26.38 | 79.17 | 11.26 | 0.2164 |
| Triglycerides (mg/dL) | 98.75 | 20.17 | 106.67 | 11.92 | 0.7386 |
| Non-esterified fatty | 0.47 | 0.03 | 0.56 | 0.05 | 0.1204 |
| acid (mEq/L) | | | | | |
| Cortisol (ug/dL) | 1.62 | 0.11 | 1.94 | 0.30 | 0.3146 |
| Bile Acids (umol/L) | 25.77 | 6.29 | 32.15 | 6.83 | 0.4991 |
| Spec cPL (ug/L) | 93.58 | 26.06 | 63.00 | 10.66 | 0.2892 |

### Example 3

The Example Composition was modified to have varying levels of tributyrin and fed to dogs to assess the palatability of the pet food compositions having different amounts of tributyrin. Dogs were fed once daily in the morning with their entire day's ration of food. Dogs were divided into 5 groups of 25 dogs each, which each group being presented with a single bowl of pet food composition that contained the base pet food composition (0 wt. % tributyrin) or a pet food compositions having a portion of the chicken fat replaced with 0.25 wt. %, 0.5 wt. %, 1 wt. %, or 2 wt. % of tributyrin to assess whether increasing tributyrin in the food decreased voluntary intake of food.

The dogs were fed their respective foods for 7 days. Dogs were pair housed but were fed daily in individual feeding stations. This was done through electronic feeders where each individually identified pet (through a chip reader) is given access to food for 1 hour of a controlled amount and then food intake is recorded. The 7 days of cumulated food intakes were assessed as the percent (%) of daily food offering which was consumed. If dogs have a food aversion to tributyrin then they consume less of the pet food composition than offered in a tributyrin dose-dependent manner compared to the base pet food composition (0% tributyrin).

Intake data was analyzed by Linear Mixed Model with animal subject as the random factor and the tributyrin level as the main effect. As shown in Table 3 (below), there was no significant effect of tributyrin level (p=0.828) and thus when the tributyrin was incorporated into the Example Composition it was as palatable as the food without tributyrin. A summary of the results is shown below in Table 3.

TABLE 3

| | Percent of | P value for effect of |
|---|---|---|
| Tributyrin (wt % | offered food | tributyrin on percent of |
| in pet food) | consumed | food consumed |
| 0 | 96.88 ± 0.35 | 0.828 |
| 0.25 | 97.71 ± 0.20 | (not significant) |
| 0.5 | 96.78 ± 0.31 | |
| 1 | 97.51 ± 0.25 | |
| 2 | 97.12 ± 0.20 | |

What is claimed is:

1. A pet food composition comprising:
about 7 wt. % or more of fat, the fat comprising one or more short chain triglyceride;
a protein; and
a fiber,
wherein all weight percentages are based on the total weight of the pet food composition on a dry matter basis.

2. The pet food composition according to claim 1, wherein the short chain triglyceride has one or more fatty acid components comprising 1 to 4 carbons.

3. The pet food composition according to claim 1, wherein the short chain triglyceride has two or more fatty acid components comprising 1 to 4 carbons.

4. The pet food composition according to claim 1, wherein the short chain triglyceride has three fatty acid components comprising 1 to 4 carbons.

5. The pet food composition according to claim 1, wherein composition comprising tributyrin, triacetin, tripropionin, or a combination thereof.

6. The pet food composition according to claim 1, wherein the short chain triglyceride comprises about 10 wt. % or more of the total amount of fat.

7. The pet food composition according to claim 1, wherein the protein is present in an amount from about 15 to 55 wt. %.

8. The pet food composition according to claim 1, wherein the fiber is present in an amount from about 1 to about 15 wt. %.

9. The pet food composition according to claim 1, wherein the pet food composition is formulated to increase in the concentration of metabolite beta-hydroxybutyrate by about 5% or more, as assessed about one hour after consumption of the pet food composition by a pet consuming a recommended daily nutritional intake of the pet food composition for a single meal.

10. The pet food composition according to claim 1, wherein the pet food composition is formulated to decrease the glucose to ketone index of a pet by about 12% or more, as assessed about one hour after consumption of the pet food composition by a pet consuming a recommended daily nutritional intake of the pet food composition for a single meal.

11. The pet food composition according to claim 1, wherein the pet food composition is formulated such that a pet has a glucose to ketone index from about 35 to about 59, as assessed about one hour after consumption of the pet food composition by a pet consuming a recommended daily nutritional intake of the pet food composition for a single meal.

12. A method for improving the health of a pet, the method comprising: increasing the concentration of metabolite beta-hydroxybutyrate in a pet by providing a pet food composition comprising protein, fiber, and about 8 wt. % or more of fat, based on the total weight of the pet food composition on a dry matter basis, the fat comprising one or more short chain triglyceride, wherein the amount of metabolite beta-hydroxybutyrate increases by about 5% or more an hour after consumption of the pet food composition by a pet.

13. The method according to claim 12, wherein the method decreases the glucose to ketone index of a pet by about 12% or more, as assessed about one hour after consumption of the pet food composition by the pet.

14. The method according to claim 12, wherein the pet has a glucose to ketone index from about 35 to about 59, as assessed about one hour after consumption of the pet food composition by the pet in the form of a single meal provided once a day for at least one day.

15. The method according to claim 12, wherein the pet is Felis domesticus.

16. A pet supplement composition comprising:
about 7 wt. % or more of fat, the fat comprising one or more short chain triglyceride;
a protein; and
a fiber,
wherein all weight percentages are based on the total weight of the pet food composition on a dry matter basis.

17. The pet food composition according to claim 16, wherein the short chain triglyceride has two or more fatty acid components comprising 1 to 4 carbons.

18. The pet supplement composition according to claim 16, wherein the short chain triglyceride has three fatty acid components comprising 1 to 4 carbons.

19. The pet supplement composition according to claim 16, wherein composition comprises tributyrin, triacetin, tripropionin, or a combination thereof.

20. The pet supplement composition according to 16, wherein the short chain triglyceride comprises about 10 wt. % or more of the total amount of fat.
